(19) United States
(12) Patent Application Publication
(10) Pub. No.: US 2015/0272796 A1
(43) Pub. Date: Oct. 1, 2015

(54) WHEELCHAIR WITH A WASTE DISPOSAL SYSTEM

(71) Applicant: Kicos Medical LLC, Cornelius, NC (US)

(72) Inventor: John Kicos, Cornelius, NC (US)

(21) Appl. No.: 14/224,980

(22) Filed: Mar. 25, 2014

(51) Int. Cl. A61G 5/10; A47K 11/04; B23P 19/04

(52) U.S. Cl. CPC A61G 5/1002; B23P 19/04; A47K 11/04

(57) ABSTRACT

A wheelchair includes a frame and a seat including a first cushion including an inner surface defining a first aperture. A second cushion includes an inner surface defining a second aperture. A receiving member is positioned between the cushions and includes an inner surface defining a channel having a first opening at a first end of the receiving member and a second opening at a second end of the receiving member. A drainage member is coupled to the second end of the receiving member and includes an inner surface defining a passageway that is in communication with each of the apertures and the channel. The passageway includes a third opening at a first end of the drainage member and a fourth opening at a second end of the drainage member. A collection container is positioned adjacent the second end of the drainage member.

### TECHNICAL FIELD

The present disclosure generally relates to wheelchairs, and more particularly to wheelchairs with a waste disposal system configured to allow a user to expel waste material without moving out of the wheelchair.

### BACKGROUND

Incontinence and over-active bladders often present a challenge to those in wheelchairs. Indeed, millions of people in wheelchairs, and those who have to sit for extended periods of time, are at the mercy of their caregivers. Urologic issues or not, most people in wheelchairs, especially seniors, are often constantly wet from urine and fecal-soaked diapers. Damp, wet diapers prevent external genitalia from drying, causing irritation to the skin, which sets the stage for skin rashes, bed sores, vaginitis, Urinary Tract Infections (UTIs), etc. As a result, many seniors purposely dehydrate themselves to avoid urination. Many people with multiple sclerosis (MS), Parkinson's, Diabetes, cancer or surgical patients have or develop urinary issues.

Devices have been developed to address incontinence and overactive bladders. However, such devices are typically invasive and/or complex. Indeed, such devices are often uncomfortable and lead to many unwanted urologic issues and infections. For example, such devices are do not address the fact that the cushions need to be very comfortable. Comfortable cushions are important during long term sitting to prevent pressure sores on the skin and are hence an important feature for wheelchair users. Rigid cushions are not conducive for long term sitting.

Disposable diapers, incontinence pads and undergarments with absorbents provide an alternative to the complex devices discussed above. However, these disposable alternatives present undesirable issues as they never dry and remain wet. Furthermore, there is no means to convey the urine and waste away from the diaper, pad or undergarment. The disposable alternatives are also not environmentally friendly.

There remains a need to provide both men and women with a comfortable, non-invasive waste collection/disposal device for a comfortable seated position in order to remain dry. The present disclosure provides an improvement over prior art technologies.

### SUMMARY

Accordingly, a wheel chair with a waste disposal system is provided. In one particular embodiment, in accordance with the principles of the present disclosure, the wheelchair includes a wheelchair frame and a wheelchair seat attached to the frame. The seat comprises a first cushion comprising an inner surface defining a first aperture. The seat comprises a second cushion comprising an inner surface defining a second aperture. A receiving member is positioned between the cushions and comprises an inner surface defining a channel having a first opening at a first end of the receiving member and a second opening at a second end of the receiving member. A drainage member is coupled to the second end of the receiving member and comprises an inner surface defining a passageway that is in communication with each of the apertures and the channel. The passageway comprises a third opening at a first end of the drainage member and a fourth opening at a second end of the drainage member. A collection container is positioned adjacent the second end of the drainage member.

In one embodiment, in accordance with the principles of the present disclosure, a kit is provided that includes a wheelchair frame and a wheelchair seat configured to be attached to the frame. The seat comprises at least one first cushion comprising an inner surface defining a first aperture; at least one second cushion comprising an inner surface defining a second aperture; at least one receiving member configured to be positioned between the cushions and comprising an inner surface defining a channel having a first opening at a first end of the receiving member and a second opening at a second end of the receiving member; at least one drainage member configured to be coupled to the second end of the receiving member and comprising an inner surface defining a passageway that is in communication with each of the apertures and the channel, the passageway comprising a third opening at a first end of the drainage member and a fourth opening at a second end of the drainage member; and at least one collection container configured to be positioned adjacent the second end of the drainage member. In some embodiments, the kit includes a plurality of first cushions, second cushions, receiving members, drainage members and/or collection containers, each having a different configuration. For example, it is envisioned that the cushions may have different densities and/or fill materials. It is further envisioned that the kit includes a plurality of first cushions, second cushions, receiving members, drainage members and/or collection containers each having an opening extending through respective components of the wheelchair that are shaped and sized differently than other similar components.

In one embodiment, in accordance with the principles of the present disclosure, the wheelchair includes a wheelchair frame and a wheelchair seat attached to the frame. The seat comprises a first cushion comprising an inner surface defining a first aperture. The seat comprises a second cushion comprising an inner surface defining a second aperture, the second cushion comprising memory foam or quilting batting. The first cushion has a density that is greater than that of the second cushion. A receiving member is positioned between the cushions and comprises an inner surface defining a channel having a first opening at a first end of the receiving member and a second opening at a second end of the receiving member. The first opening has a maximum diameter that is greater than that of the second opening. The channel is tapered between the first and second ends. A drainage member defines a funnel comprising a flexible material. The drainage member is coupled to the second end of the receiving member and comprises an inner surface defining a passageway that is in communication with each of the apertures and the channel. The passageway comprises a third opening at a first end of the drainage member and a fourth opening at a second end of the drainage member. A collection container is positioned adjacent the second end of the drainage member. The receiving member comprises a body that includes the channel and a flange extending outwardly from an upper surface of the body such that a bottom surface of the flange engages a top surface of the first cushion and a top surface of the flange engages a bottom surface of the second cushion to fix the receiving member relative to the cushions. The receiving member extends along a longitudinal axis between the first and second ends thereof. The channel has a first portion adjacent the first opening that extends transverse to the longitudinal axis and a second portion adjacent the second opening that extends parallel to the longitudinal axis. The second portion extends at an angle of about 60 degrees relative to the longitudinal axis.

### BRIEF DESCRIPTION OF THE DRAWINGS

The present disclosure will become more readily apparent from the specific description accompanied by the following drawings, in which:

FIG. 1 is a perspective view of one particular embodiment of a wheelchair in accordance with the principles of the present disclosure;

FIG. 2 is a perspective view of components of the wheelchair shown in FIG. 1, in part phantom;

FIG. 3 is a perspective view of components of the wheelchair shown in FIG. 1;

FIG. 4 is a perspective view of components of the wheelchair shown in FIG. 1, in part phantom;

FIG. 5 is a perspective view of components of the wheelchair shown in FIG. 1, in part phantom;

FIG. 6 is a side view of a component of the wheelchair shown in FIG. 1;

FIG. 7 is a top view of a component of the wheelchair shown in FIG. 1;

FIG. 8 is a rear view of components of the wheelchair shown in FIG. 1;

FIG. 9 is side view of components of the wheelchair shown in FIG. 1;

FIG. 10 is rear view of components of the wheelchair shown in FIG. 1; and

FIG. 11 is rear view of components of the wheelchair shown in FIG.

Like reference numerals indicate similar parts throughout the figures.

### DETAILED DESCRIPTION

In one embodiment, the wheelchair of the present disclosure includes a seat and a bottom comfort cushion with a rectangular opening to receive an open top collection/drainage funnel. The funnel is of sufficient size and proportion to receive voided materials, such as, for example, human urine and/or feces, to substantially prevent leakage of said materials onto the cushion during voiding. A proximal end of a drainage element engages the funnel. The drainage element is in fluid communication with the funnel. A collection container is configured for receiving the voided waste material. The collection container is attached to or around a distal end of the drainage element and is in fluid communication with the drainage element. In some embodiments, the opening in the bottom comfort cushion may have various cross section configurations, such as, for example, oval, circular, oblong, triangular, rectangular, square, polygonal, irregular, uniform, non-uniform, variable, tubular and/or tapered.

In one embodiment, the wheelchair of the present disclosure includes top and bottom comfort cushions and a funnel with a collection container. The bottom comfort cushion has a rectangular hole or opening. The funnel is disposed in the opening such that the funnel is positioned between the cushions. The funnel is rigid but flexible and has two openings. A top opening of the funnel is oval in shape. The funnel has an approximately 2 inch rim that extends around a circumference of a body of the funnel at a proximal or top end of the funnel. The walls of the funnel narrow and deepen in the middle to form a bottom drain opening. A collection container surrounds the drain opening under the seat. In some embodiments, the hole or opening in the bottom comfort cushion and/or the top opening of the funnel may have various cross section configurations, such as, for example, oval, circular, oblong, triangular, rectangular, square, polygonal, irregular, uniform, non-uniform, variable, tubular and/or tapered. In some embodiments, all or only a portion of the funnel is fabricated from a semi-rigid, rigid or elastic configuration, relative to other components of the wheelchair and/or have elastic properties, such as the elastic properties corresponding to the material examples described herein.

In some embodiments, the top opening has an oval configuration and is about 11 inches long and about 3.5 inches wide. In some embodiments, the rim extends outwardly about 2 inches from the circumference of the body of the funnel. In some embodiments, the walls of the funnel are about 4 inches deep, which allows the external genitalia both male and female to stay dry, preventing skin contact with wet materials while remaining in a seated position.

In one embodiment, the wheelchair of the present disclosure includes a modified seat with an opening for a drainage element, such as, for example, a funnel. In some embodiments, the chair seat is about 18 inches wide by about 16 inches deep. It is envisioned that the size of the chair seat may vary according to user's size and/or weight, for example. There is an opening at a back of the seat that is about 4 inches wide by about 5 inches deep, starting 1 inch from a back edge of the seat in the middle. The opening at the back of the seat is square in shape and allows a bottom drainage part of a funnel to pass through the chair seat. In some embodiments, edges of the opening at the back of the seat are reinforced all around with safety webbing, such as, for example, 1,200 pound safety webbing for extra strength.

The wheelchair includes a bottom comfort cushion with openings configured for disposal of a funnel. The bottom cushion is about 15 inches wide by 16 inches deep and between 3 to 4 inches thick. The thickness of the bottom cushion will vary depending on the user's size and weight. The density of the bottom cushion is more stiff or firm relative to a bottom cushion, as will be discussed. More firmness in the bottom cushion is required to support the weight of the user and house the funnel without interference with bottom crossbars in the middle of the chair. There is an opening or hole in the middle of the bottom cushion. The opening in the middle of the bottom cushion is about 1 inch from the back middle of the cushion. The opening in the middle of the bottom cushion is about 4 inches wide by about 13 inches long and is square in shape. The bottom cushion is covered with soft cleanable fabrics or removable covers to facilitate cleaning and/or to prevent the bottom cushion from becoming soiled with dirt, oil, etc. The funnel fits into the bottom comfort cushion in a location to receive voided waste flow, the body of sufficient size and proportion to receive the voided waste flow to substantially prevent leakage of voided waste onto the seat cushion assembly during voiding. In some embodiments, all or only a portion of the opening in the middle of the bottom cushion may be variously configured and dimensioned, such as, for example, planar, concave, polygonal, irregular, uniform, non-uniform, staggered, tapered, consistent or variable, depending on the requirements of a particular application.

In some embodiments, the funnel is oblong in shape from front to back and has a length of about 14 inches and a width of about 8 inches. The funnel includes a body having an approximately 2 inch rim extending outwardly from the body around a top circumference of the body. The height of the funnel is about 9 inches. The back third of the funnel angles down and back about 60 degrees and is about 4 inches round in diameter and about 6 inches long. The depth of the funnel in the front is about 2 inches deep by 2 inches wide. The depth and width of the funnel both gradually increase towards the back of the funnel. The middle of the funnel is about 4 inches deep by 4 inches wide to allow the back angle of the funnel to clear the crossbars in the middle of the wheelchair.

The seat includes a single molded piece defining a drainage element comprising a conduit that is in fluid communication with a lumen of the funnel to direct voided materials away from the user's body. A top comfort cushion includes an opening to allow external genitalia to be positioned within the lumen of the funnel and stay dry is placed onto a proximal end of the funnel. The top cushion is approximately 15 inches wide by about 16 inches deep and is about 2 inches thick. The top cushion is made with a memory foam or quilting batting to allow proper comfort required for long term sitting. The dimensions of the top cushion will vary according to chair and wheelchair size and/or the size and/or weight of the user. There is an opening or hole about 4 inches wide by about 13 inches long in the middle of the cushion starting about one inch from the back middle of the cushion. The top cushion has Velcro® on the bottom in order to keep it in proper position with the funnel insert underneath with in the bottom cushion. The top cushion is covered with a soft yet washable fabrics or removable covers.

In some embodiments, the funnel and the collection container are removable and reusable. In some embodiments, the funnel is made from material comprising plastic, rubber, polyurethane, urethane, or silicone. In some embodiments, the funnel is made from polyurethane, urethane, rubber, or plastic having a thickness ranging from about 0.05 cm to about 1 cm. In some embodiments, the body of the funnel has a length along a longitudinal Y axis of the body within a range from about 30 cm to about 35 cm and a horizontal X axis of the body falls within a range of from about 20 cm to about 25 cm, and wherein the body of the funnel is molded in a boat-like shape with a flange around the rim. The flange or rim of the body of the funnel falls within a range of from about 4 cm to about 7 cm. In some embodiments, the funnel is waterproof and includes an open hollow proximal end that is removably affixed to the seat cushion. In some embodiments, the drainage element is permanently fixed to a hollow distal end of the funnel. In some embodiments, the drainage element extends at least about 3 inches from the distal end of the funnel and the body of the funnel and the drainage element are in fluid communication to provide a substantially leak-proof seat cushion. In some embodiments, the collection container is a bucket that is detachably connected or surrounding the drainage element.

In some embodiments, at least one of the wheels of the wheelchair are covered with a material to hide the view of the collection container when viewed from a first side of the wheelchair or a second side of the wheelchair. In some embodiments, the material is fixed to the wheels using a hook and loop fastener, such as, for example, Velcro®. In some embodiments, a first flap of material extends perpendicular to the wheels from a frame of the wheelchair and is configured to hide the view of the collection container when the wheelchair is viewed from a front of the wheelchair and/or a second flap of material extends perpendicular to the wheels from the frame of the wheelchair that is spaced apart from the first flap of material and is configured to hide the view of the collection container when the wheelchair is viewed from a back of the wheelchair. In some embodiments, at least one of the first and second flaps is about 15 inches long by about 12 inches wide. In some embodiments, at least one of the first and second flaps is fixed to the frame of the wheelchair using a hook and loop fastener, such as, for example, Velcro®.

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

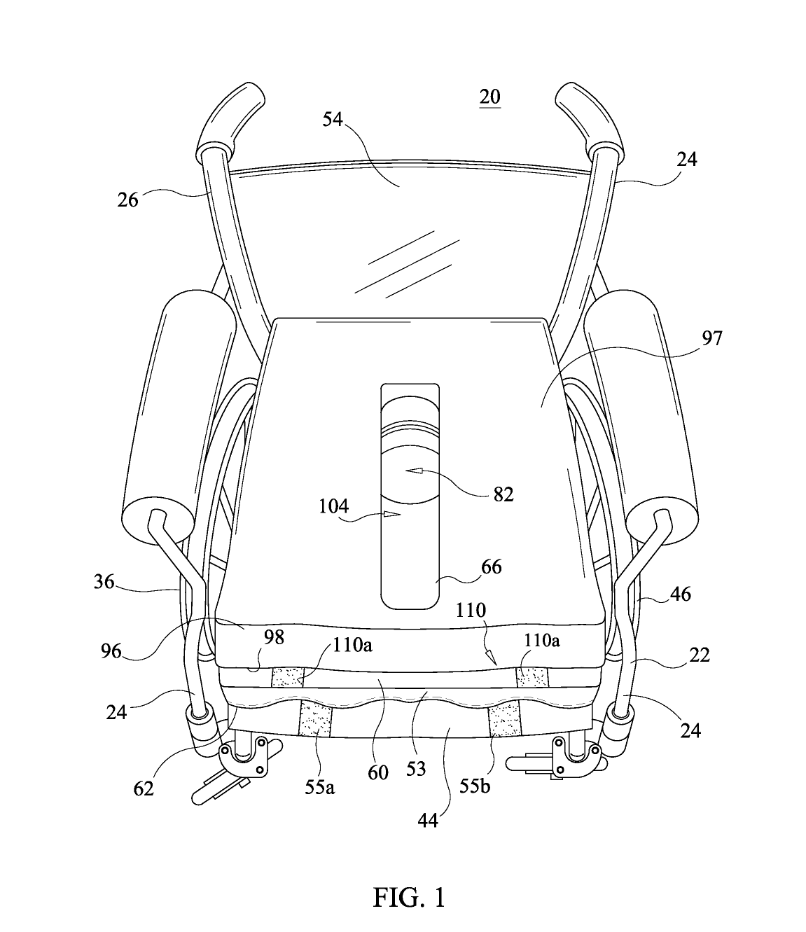

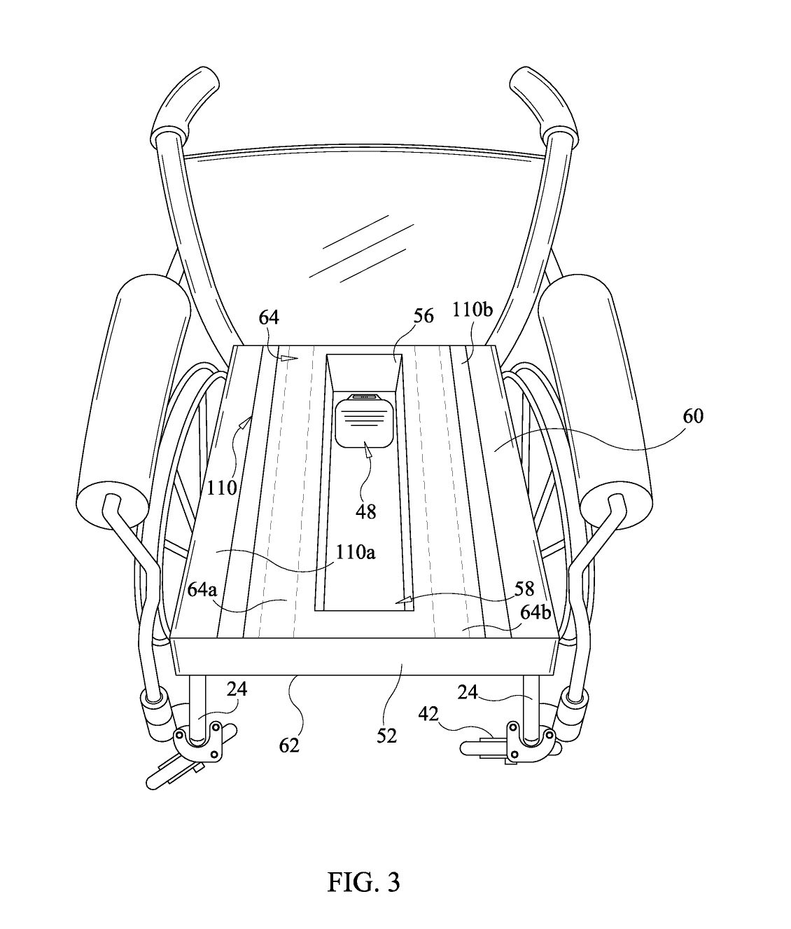

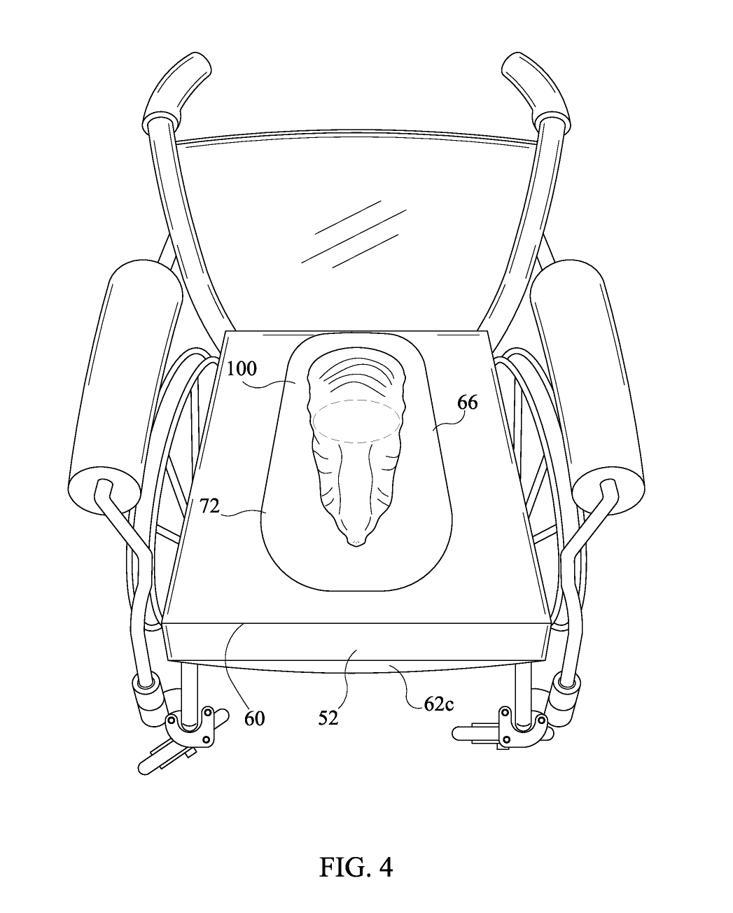

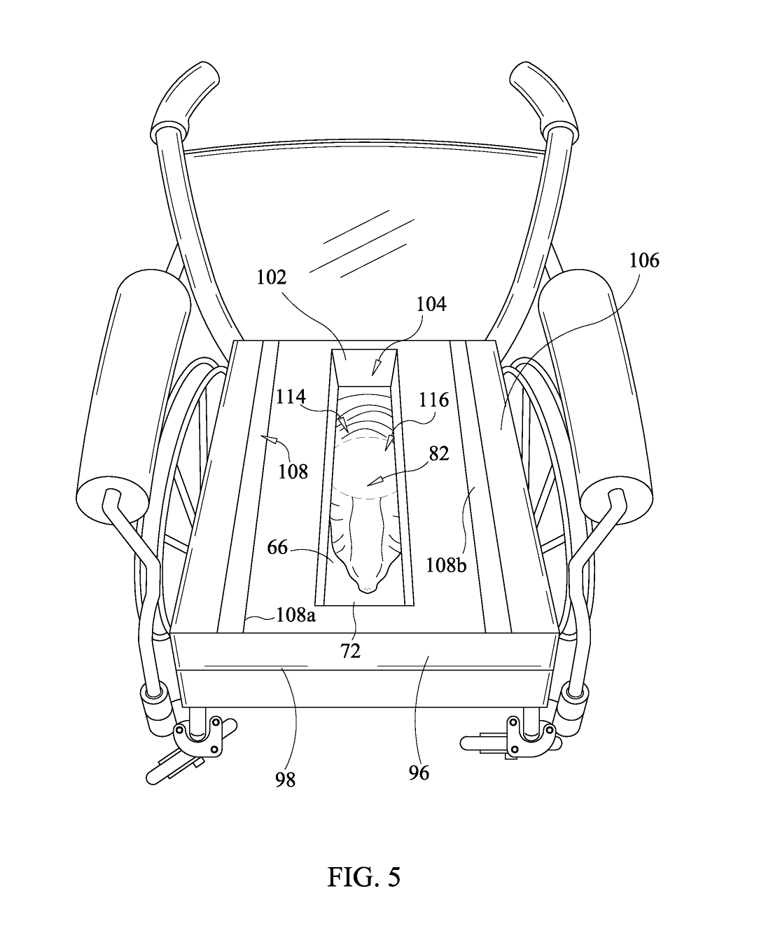

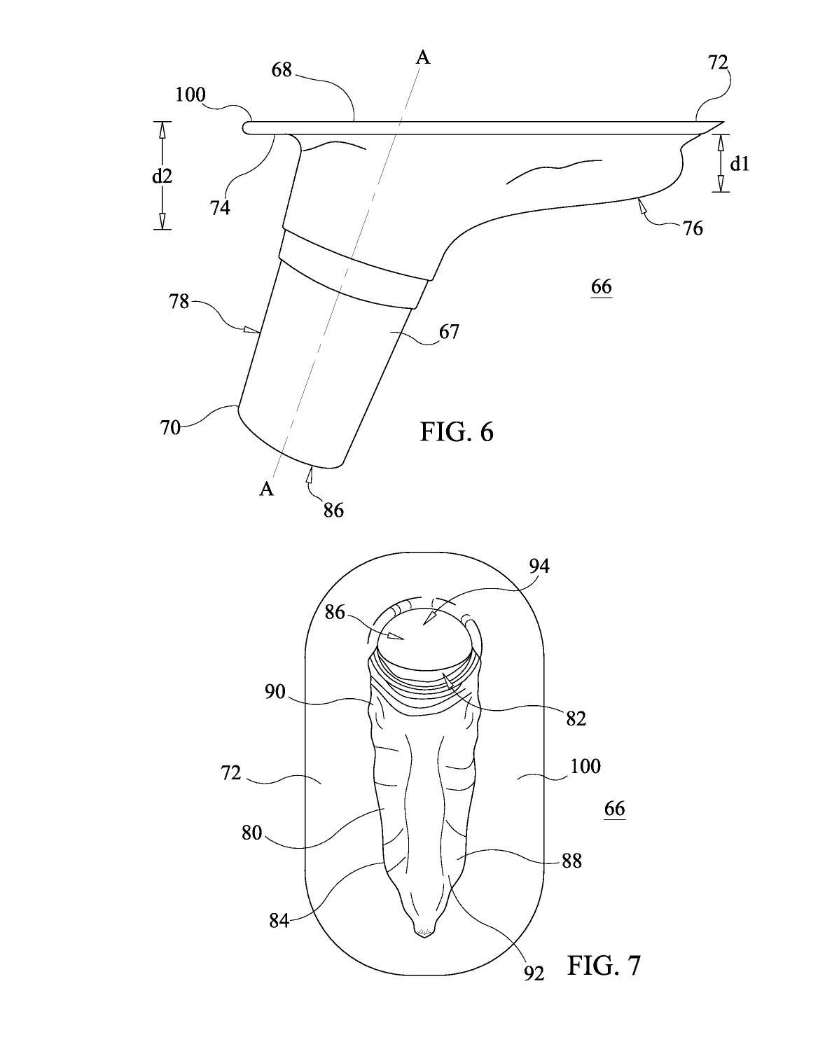

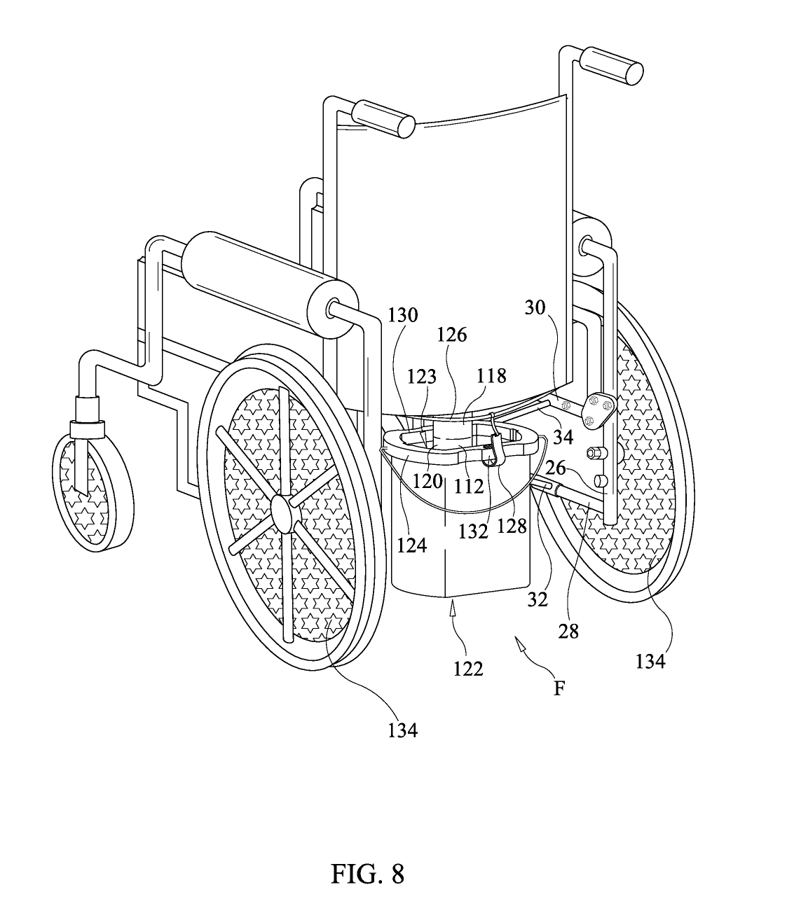

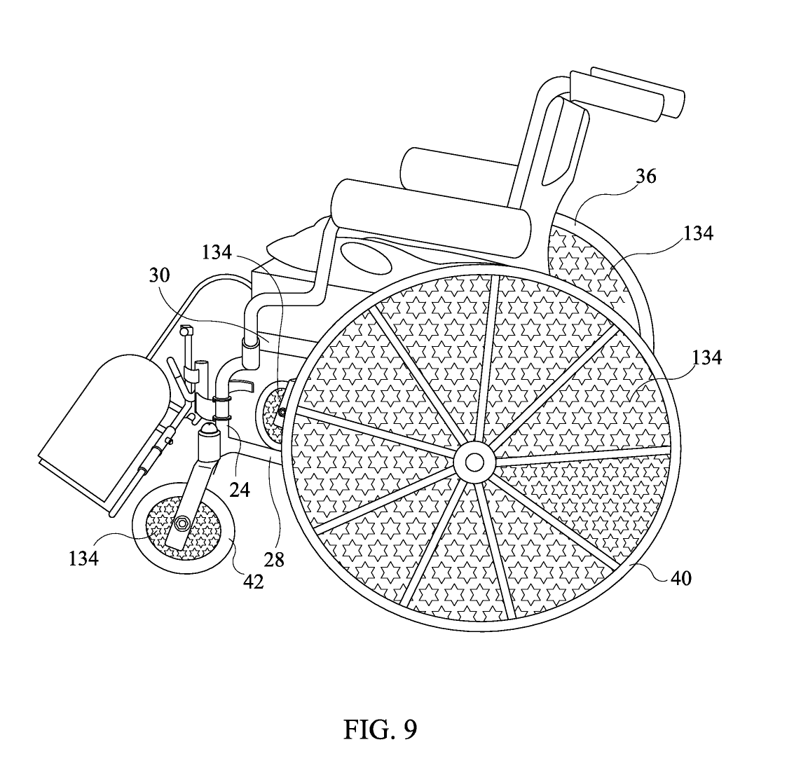

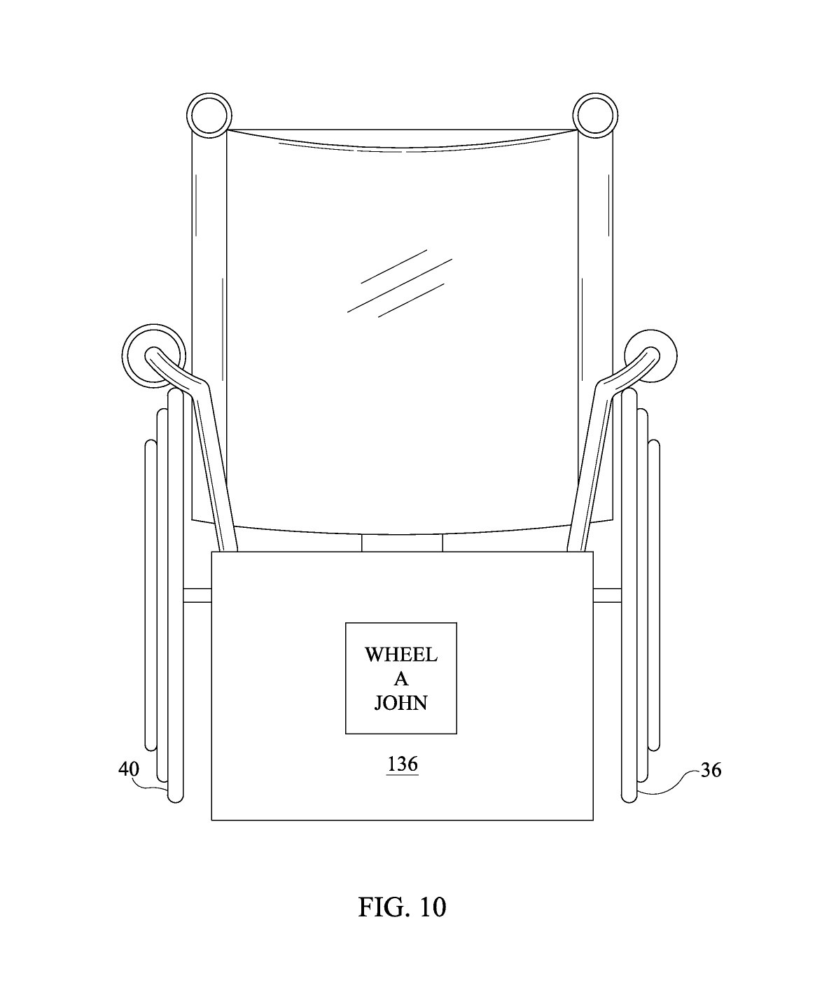

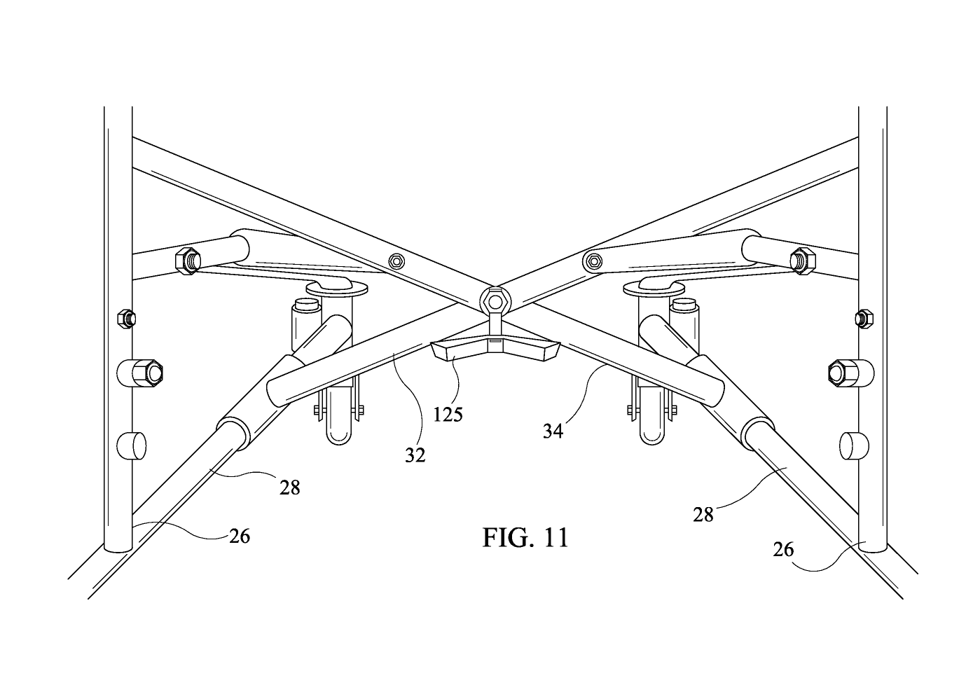

The following discussion includes a description of a wheelchair including a waste disposal system, related components and exemplary kits in accordance with the principles of the present disclosure. Alternate embodiments are also disclosed. Reference will now be made in detail to the exemplary embodiments of the present disclosure, which are illustrated in the accompanying figures. Turning now to FIGS. 1-10, there are illustrated components of one embodiment of a wheelchair 20, in accordance with the principles of the present disclosure.

The components of wheelchair 20 are fabricated from materials including metals, polymers, plastic, rubber, polyurethane, urethane, silicone, depending on the particular application. Various components of wheelchair 20 may have material composites, including the above materials, to achieve various desired characteristics such as strength, rigidity or elasticity. The components of wheelchair 20, individually or collectively, may also be fabricated from a heterogeneous material such as a combination of two or more of the above-described materials. The components of wheelchair 20 may be monolithically formed, integrally connected or include fastening elements and/or instruments, as described herein.

Wheelchair 20 includes a frame 22 comprising a pair of spaced apart forward vertical rails 24 and a pair of spaced apart rearward vertical rails 26. A pair of spaced apart first horizontal rails 28 couple lower portions of forward and rearward vertical rails 24, 26 and a pair of second horizontal rails 30 couple upper portions of forward and rearward vertical rails 24, 26. A first crossbar 32 extends from a first one of horizontal rails 28 to a first one of horizontal rails 30 positioned on an opposite side of frame 22 as the first one of horizontal rails 28 and a second crossbar 34 extends from a second horizontal rail 28 opposite the first one of horizontal rails 28 and a second one of horizontal rails 30 positioned opposite the first one of horizontal rails 30. A first side of frame 22 includes a first large wheel 36 and a first small wheel 38 rotatably coupled thereto and a second side of frame 22 includes a second large wheel 40 and a second small wheel 42 rotatably coupled thereto. In some embodiments, rails 24, 26, 28, 30 and/or crossbars 34, 34 are fixed relative to one another. In some embodiments, rails 24, 26, 28, 30 and/or crossbars 34, 34 are movable relative to one another to allow frame 22 to move from an expanded configuration, shown in FIG. 1, for example, and a collapsed configuration in which frame 22 occupies a reduced volume of space. In some embodiments, large wheels 36, 40 each have a diameter of about 22 inches and small wheels 38, 42 each have a diameter of about 6 to about 8 inches.

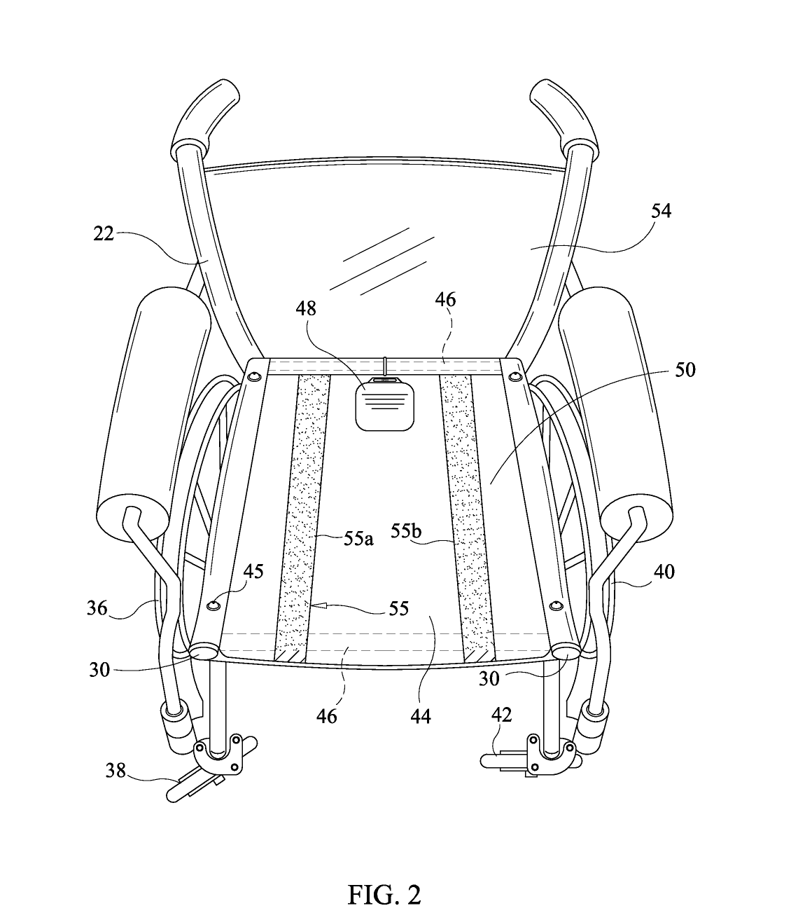

A seat 44 extends between second horizontal rails 30. Seat 44 is further supported by a pair of spaced apart transverse rails 46 that extend perpendicular to second horizontal rails 30 and connect second horizontal rails 30. Seat 44 is fixed to frame 22 via screws 45 that extend through seat 44 and second horizontal rails 30. Transverse rails 46 are shown in phantom in FIG. 2. Seat 44 includes a throughhole 48 having a square or rectangular cross sectional configuration. In some embodiments, at least a portion of through hole 48 is reinforced with safety webbing, such as, for example, 1,200 pound safety webbing for extra strength. In some embodiments, throughhole 48 is about 4 inches wide and has a depth of about 5 inches. In some embodiments, throughhole 48 is positioned approximately 1 inch from one of transverse rails 46 positioned adjacent a back support 54 of wheelchair 20. In some embodiments, throughhole 48 is positioned equidistant between second horizontal rails 30. An upper surface 50 of seat 44 includes a fastening means, such as, for example, a hook and loop fastener 55 to fix a bottom comfort cushion, such as, for example, a first cushion 52 to seat 44. In some embodiments, hook and loop fastener 55 includes a first strip 55a positioned one on one side of through hole 48 and a second strip 55b positioned on an opposite side of throughhole 48. In some embodiments, seat 44 is folded over transverse rails 46 to conceal the same.

In some embodiments, seat 44 comprises a flexible material to facilitate folding of frame 22. In some embodiments, seat 44 comprises a rigid material. In some embodiments, seat 44 has a width defined by the distance between horizontal rails 26 of about 15 inches and a depth of about 16 inches. In some embodiments, seat 44 includes a cushioning material disposed between inner and outer layers of seat 44. In some embodiments, seat 44 is free of any cushioning material. In some embodiments, throughhole 48 may have various cross section configurations, such as, for example, circular, oval, oblong, triangular, rectangular, square, polygonal, irregular, uniform, non-uniform, variable, tubular and/or tapered. In some embodiments, hook and loop fastener 52 covers all or only a portion of upper surface 50. In some embodiments, seat 44 can be variously connected with first cushion 52, such as, for example, monolithic, integral connection, frictional engagement, threaded engagement, mutual grooves, screws, adhesive, nails, barbs and/or raised element.

First cushion 52 comprises an inner surface 56 defining a first aperture 58 having a rectangular cross sectional configuration. In some embodiments, first aperture 58 is positioned approximately 1 inch from one of transverse rails 46 positioned adjacent back support 54 and extends through and between an upper surface 60 of first cushion 52 and an opposite lower surface 62 of first cushion 52 such that first aperture 58 includes a first opening adjacent upper surface 60 and a second opening adjacent lower surface 62. The second opening is aligned with throughhole 48 such that throughhole 48 is in fluid communication with first aperture 58. In some embodiments, first aperture 58 may have various cross section configurations, such as, for example, circular, oval, oblong, triangular, rectangular, square, polygonal, irregular, uniform, non-uniform, variable, tubular and/or tapered. Lower surface 62 includes a fastening means, such as, for example, a hook and loop fastener 64 that engages hook and loop fastener 55 to fix first cushion 52 to seat 44. In some embodiments, hook and loop fastener 64 includes a first strip 64a positioned one on one side of first aperture 58 that engages strip 55a and a second strip 64b positioned on an opposite side of first aperture 58 that engages strip 55b. In some embodiments, hook and loop fastener 64 covers all or only a portion of lower surface 62. In some embodiments, first aperture 58 is positioned equidistant between second horizontal rails 30.

First cushion 52 comprises a cushioning material, such as, for example, polyester, memory foam, latex, rubber or a gel. In some embodiments, first cushion 52 comprises a cushioning material having heat dissipation properties. In some embodiments, first cushion 52 comprises a cushioning material configured to trap heat. In some embodiments, first cushion 52 is about 15 inches wide by about 16 inches deep, such that first cushion 52 completely covers seat 44. In some embodiments, first cushion 52 defines an area that is less than that defined by seat 44 such that first cushion 52 does not completely cover seat 44, which may be desirable to facilitate folding of wheelchair 20 and/or to provide access to components of wheelchair 20, such as, for example, screws 45 used to fix seat 44 to frame 22. As such, in embodiments where first cushion 52 does not completely cover seat 44, first cushion 52 may be spaced apart from screws 45. In some embodiments, first cushion 52 has a thickness of about 3 to about 4 inches. In some embodiments, the thickness and/or density of first cushion 52 will vary depending upon, for example, the weight of a user. In some embodiments, first cushion 52 comprises a cover 53, as shown in FIG. 1 that encloses the cushioning material of first cushion 52 to prevent the bottom cushion from becoming soiled with dirt, oil, etc. In some embodiments, cover 53 is removable to facilitate cleaning of the cushioning material. In embodiments that include cover 53, the cushioning material of first cushion may include, for example, polyester pellets, microbeads, polystyrene beads, foam, feathers, wool, horsehair and/or shredded rubber.

A receiving member, such as, for example, a funnel 66 having a body 67 is positioned relative to seat 44 and first cushion 52 such that a first end 68 of funnel 66 is positioned in first aperture 58 and an opposite second end 70 of funnel 66 extends through throughhole 48. An upper surface of first end 68 includes a rim, such as, for example a flange 72 extending outwardly and radially from body 67. A bottom surface 74 of flange 72 engages upper surface 60 to fix funnel 66 relative to first cushion 52. In some embodiments, bottom surface 74 and/or upper surface 60 may have various surface configurations, such as, for example, smooth and/or surface configurations to enhance fixation with the other of bottom surface 74 and upper surface 60, such as, for example, rough, arcuate, undulating, porous, semi-porous, dimpled, polished and/or textured. In some embodiments, flange 72 extends about 2 inches outwardly from body 67. In some embodiments, funnel comprises a flexible material. In some embodiments, funnel 66 is removable relative to first cushion 52. In some embodiments, funnel 66 is integrally formed with first cushion 52 such that first cushion 52 and funnel 66 are monolithic. In some embodiments, flange 72 is removable from body 67 to facilitate cleaning of flange 72 and/or body 67. In some embodiments, flange 72 and body 67 are monolithic.

Funnel 66 includes a first portion 76 adjacent first end 68 and a second portion 78 adjacent second end 70 that defines a longitudinal axis A. First portion 76 extends transverse to longitudinal axis A such that first portion 76 and/or flange 72 extends at an angle between about 30 degrees and about 75 degrees relative to longitudinal axis A. In some embodiments, flange 72 and/or first portion 76 extend at an angle of about 45 degrees relative to longitudinal axis A. In some embodiments, flange 72 and/or first portion 76 extend at an angle of about 60 degrees relative to longitudinal axis A. In some embodiments, funnel 66 has a height defined by the distance between first end 68 and second end 70 that is about 9 inches. In some embodiments, funnel 66 has a width of about 8 inches.

An inner surface 80 of funnel 66 defines a channel 82 having a first opening 84 at first end 68 and a second opening 86 at second end 70. First opening 84 has a maximum diameter that is greater than that of second opening 86. Channel 82 has a volume sufficient to receive voided waste material, such as, for example, urine and/or feces in a manner that substantially prevents leakage of the voided waste material onto components of wheelchair 20. Channel 82 includes a first section 88 adjacent first end 68 and a second section 90 adjacent second end 70 that is coaxial with longitudinal axis A. First section 88 extends transverse to longitudinal axis A such that first section 88 extends at an angle between about 30 degrees and about 75 degrees relative to longitudinal axis A to prevent second portion 90 from contacting crossbars 32, 34. In some embodiments, first section 88 extends at an angle of about 45 degrees relative to longitudinal axis A. In some embodiments, first section 88 extends at an angle of about 60 degrees relative to longitudinal axis A. In some embodiments, second section 90 has a uniform diameter. In some embodiments, second section 90 has a uniform diameter of about 4 inches and has a length of about 6 inches. In some embodiments, second opening 86 may have various cross section configurations, such as, for example, oval, oblong, triangular, rectangular, square, polygonal, irregular, uniform, non-uniform, variable, tubular and/or tapered.

First section 88 includes a front portion 92 having a first width w1 and a first depth d1. First section 88 deepens and widens from front portion 92 to an opposite back portion 94 such that back portion 94 has a second width w2 and a second depth d2, which are each greater than first width w1 and a first depth d1, respectively. Back portion 94 is positioned closer to back support 54 than front portion 92. In some embodiments, first section 88 deepens and widens continuously between front portion 92 and back portion 94. In some embodiments, a midsection between front portion 92 and back portion 94 has a width of about 4 inches and a depth of about 4 inches.

A second cushion 96 is positioned on top of first cushion 52 such that a bottom surface 98 of second cushion 96 engages a top surface 100 of flange 72 and upper surface 60 such that funnel 66 is positioned between first cushion 52 and second cushion 96 to fix funnel 66 relative to first cushion 52 and second cushion 96. Second cushion 96 comprises an inner surface 102 defining a second aperture 104 having a rectangular cross sectional configuration. Second aperture 104 is configured for disposal of external genitalia. Second cushion 96 is positioned relative to first cushion 52 such that second aperture 104 is aligned with first aperture 58. In some embodiments, second aperture 104 is positioned approximately 1 inch from one of transverse rails 46 positioned adjacent back support 54 and extends through and between a top surface 106 of second aperture 104 and bottom surface 98 such that second aperture 104 includes a first opening adjacent top surface 106 and a second opening adjacent bottom surface 98. The second opening of second cushion 96 is aligned with first opening 84 such that first opening 84 is in fluid communication with second aperture 104. In some embodiments, second aperture 104 may have various cross section configurations, such as, for example, circular, oval, oblong, triangular, rectangular, square, polygonal, irregular, uniform, non-uniform, variable, tubular and/or tapered. In some embodiments, second aperture 104 is positioned equidistant between second horizontal rails 30.

Bottom surface 98 includes a fastening means, such as, for example, a hook and loop fastener 108 that engages a hook and loop fastener 110 on upper surface 60 to fix first cushion 52 to second cushion 96. In some embodiments, hook and loop fastener 108 includes a first strip 108a positioned one on one side of second aperture 104 and a second strip 104b positioned on an opposite side of second aperture 104 and hook and loop fastener 110 includes a first strip 110a positioned one on one side of first aperture 58 that engages first strip 108a and a second strip 110b positioned on an opposite side of first aperture 58 that engages second strip 108b. In some embodiments, hook and loop fastener 108 covers all or only a portion of bottom surface 98. In some embodiments, hook and loop fastener 110 covers all or only a portion of upper surface 60.

Second cushion 96 comprises a cushioning material, such as, for example, polyester, memory foam, latex, rubber or a gel. In some embodiments, second cushion 96 comprises memory foam or quilting batting. In some embodiments, second cushion 96 is less dense than first cushion 96. It is envisioned that first cushion 52 is required to be denser than second cushion 52 to support the weight of a user and/or prevent interference with crossbars 32, 34. In some embodiments, second cushion 96 comprises a cushioning material having heat dissipation properties. In some embodiments, second cushion 96 comprises a cushioning material configured to trap heat. In some embodiments, second cushion 96 is about 15 inches wide by about 16 inches deep, such that second cushion 96 completely covers first cushion 52. In some embodiments, second cushion 96 defines an area that is less than that defined by first cushion 52 such that second cushion 96 does not completely first cushion 52. In some embodiments, second cushion 96 has a thickness of about 2 inches. In some embodiments, the thickness and/or density of second cushion 96 will vary depending upon, for example, the weight of a user. In some embodiments, second cushion 96 comprises a cover 97, as shown in FIG. 1 that encloses the cushioning material of second cushion 96 to prevent second cushion 96 from becoming soiled with dirt, oil, etc. In some embodiments, cover 97 is removable to facilitate cleaning of the cushioning material of second cushion 96. In embodiments that include cover 57, the cushioning material of second cushion 96 may include, for example, polyester pellets, microbeads, polystyrene beads, foam, feathers, wool, horsehair and/or shredded rubber.

A drainage member 112 is coupled to second end 70 and includes an inner surface 114 defining a passageway 116 having a cylindrical cross sectional configuration. A first end 118 of passageway 116 defines a first opening of drainage member 112 that is in communication with channel 82 and a second end 120 of passageway 116 defines a second opening of drainage member 112. Passageway 116 has a uniform diameter that is greater than a maximum diameter of second end 70 such that at least a portion of second end 70 is positioned within passageway 116. In some embodiments, drainage member 112 is formed from a single molded piece. In some embodiments, passageway 116 may have various cross section configurations, such as, for example, oval, oblong, triangular, rectangular, square, polygonal, irregular, uniform, non-uniform, variable, tubular and/or tapered. In some embodiments, inner surface 112 may have various surface configurations, such as, for example, smooth and/or surface configurations to enhance fixation with an outer surface of funnel 66, such as, for example, rough, arcuate, undulating, porous, semi-porous, dimpled, polished and/or textured. In some embodiments, drainage member 112 can be variously connected with funnel 66, such as, for example, monolithic, integral connection, frictional engagement, threaded engagement, mutual grooves, screws, adhesive, nails, barbs and/or raised element.

A collection container 122 is positioned below second end 120 and is configured to catch voided waste material that moves out of second end 120. A cavity 123 defined by an inner surface of collection container 122 has a maximum diameter that is greater than that of drainage member 112 such that at least a portion of second end 120 is positioned within cavity 123. In some embodiments, at least one of crossbars 32, 34 includes a bracket 125 that fits under a lip 124 at a first end 130 of collection container 122 to prevent collection container 122 from touching a floor F upon which wheels 36, 38, 40, 42 rest. In some embodiments, a stabilization member, such as, for example, a strap 126 extends between second horizontal rails 30. Strap 126 includes a hook 128 rotatably disposed on strap 126. Hook 128 fits under lip 124 at a second end 132 of collection container 122 to prevent collection container 122 from touching floor F. In some embodiments, collection container 122 is a bag, bottle or bucket. In some embodiments, collection container 122 is removable from wheelchair 20 without removing drainage member 112. In some embodiments, collection container 122 and drainage member 112 are monolithic such that collection container 122 and drainage member 112 are removable from wheelchair 20 as a single piece.

In some embodiments, at least one of wheels 36, 38, 40, 42 include a cover 134 configured to conceal collection container 122 from view, when viewed in a direction that is parallel to transverse rails 46. In some embodiments, a first protection flap 136 extends perpendicularly from a rearward one of transverse rails 46 to conceal collection container 122 from view, when viewed in a direction that is parallel to second horizontal rails 30 from a rear of wheelchair 20. In some embodiments, a second protection flap similar to first protection flap 136 extends perpendicularly from a front one of transverse rails 46 to conceal collection container 122 from view, when viewed in a direction that is parallel to second horizontal rails 30 from a front of wheelchair 20.

In operation and use, first cushion 52 is positioned relative to seat 44 such that strips 64a, 64b engage strips 55a, 55b to fix first cushion relative to seat 44 and first aperture 58 is in communication with throughhole 48. Funnel 66 is positioned in first aperture 58 such that bottom surface 74 engages upper surface 60 and second end 70 extends through throughhole 48. Second cushion 96 is positioned relative to first cushion 52 such that strips 110a, 110b engage strips 108a, 108b to fix second cushion 96 relative to first cushion 52. Drainage member 112 is coupled to funnel 66 such that passageway 116 is in communication with channel 82. Collection container 122 is positioned relative to drainage member 112 such that passageway 116 is in communication with cavity 123. This configuration allows voided waste material, such as, for example, urine and/or feces, to be deposited in second aperture 104 while a user sits upon second cushion 96. The voided waste material moves through aperture 104 into front portion 92 and/or back portion 94. The voided waste material moves through front portion 92 and/or back portion 94 and into second portion 78. The voided waste material moves through channel 82 and into passageway 116. The voided waste material moves through passageway 116 and into cavity 123. Once the voided waste material is deposited in cavity 123, collection container 122 can be removed from wheelchair 20 and replaced with a second, clean collection container 122. In some embodiments, bracket 125 is positioned under lip 124 at a first end 130 of collection container 122 and hook 128 is under lip 124 at second end 132 of collection container 122 to prevent collection container 122 from touching floor F.

In some embodiments, seat 44 forms a portion of a piece of furniture, such as, for example, a chair that lacks wheels to accommodate users that are not in wheelchairs, yet may not always be able to stand and walk to a bathroom to void waste material, such as, for example, urine and/or feces. It is envisioned that such devices may be useful for seniors as well as children and infants, who are not fully potty trained. It is therefore beneficial to provide seat 44 in stationary items of furniture. In such embodiments, seat 44 may be fixed to a frame of a stationary item of furniture, such as, for example, a chair. In some embodiments, a cushion of the chair is removed and seat 44 is replaced with the cushion. First cushion 52 is positioned relative to seat 44 such that strips 64a, 64b engage strips 55a, 55b to fix first cushion relative to seat 44 and first aperture 58 is in communication with throughhole 48. Funnel 66 is positioned in first aperture 58 such that bottom surface 74 engages upper surface 60 and second end 70 extends through throughhole 48. Second cushion 96 is positioned relative to first cushion 52 such that strips 110a, 110b engage strips 108a, 108b to fix second cushion 96 relative to first cushion 52. Drainage member 112 is coupled to funnel 66 such that passageway 116 is in communication with channel 82. Collection container 122 is positioned relative to drainage member 112 such that passageway 116 is in communication with cavity 123.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A wheelchair, comprising:
a wheelchair frame; and
a wheelchair seat attached to the frame, the seat comprising:
a first cushion comprising an inner surface defining a first aperture,
a second cushion comprising an inner surface defining a second aperture,
a receiving member positioned between the cushions and comprising an inner surface defining a channel having a first opening at a first end of the receiving member and a second opening at a second end of the receiving member,
a drainage member coupled to the second end of the receiving member and comprising an inner surface defining a passageway that is in communication with each of the apertures and the channel, the passageway comprising a third opening at a first end of the drainage member and a fourth opening at a second end of the drainage member, and
a collection container positioned adjacent the second end of the drainage member.

2. A wheelchair as recited in claim 1, wherein the receiving member is a funnel.

3. A wheelchair as recited in claim 1, wherein the first opening has a maximum diameter that is greater than that of the second opening.

4. A wheelchair as recited in claim 1, wherein the receiving member comprises a flexible material.

5. A wheelchair as recited in claim 1, wherein the receiving member comprises a body that includes the channel and a flange extending outwardly from an upper surface of the body such that a bottom surface of the flange engages a top surface of the second cushion and a top surface of the flange engages a bottom surface of the first cushion to fix the receiving member relative to the cushions.

6. A wheelchair as recited in claim 5, wherein the flange is removable from the body to facilitate cleaning thereof.

7. A wheelchair as recited in claim 1, wherein a bottom surface of the second cushion comprises a first part of a hook and loop fastener that engages a second part of the hook and loop fastener positioned on a top surface of the first cushion to fix the first cushion relative to the second cushion.

8. A wheelchair as recited in claim 1, wherein the receiving member extends along a longitudinal axis between the first and second ends thereof, the channel having a first portion adjacent the first opening that extends transverse to the longitudinal axis and a second portion adjacent the second opening that extends parallel to the longitudinal axis.

9. A wheelchair as recited in claim 8, wherein the second portion extends at an angle of about 60 degrees relative to the longitudinal axis.

10. A wheelchair as recited in claim 8, wherein the frame includes a back support that extends perpendicular to the seat, the first portion is positioned closer to the back support than the second portion.

11. A wheelchair as recited in claim 1, wherein the first cushion has a density that is greater than that of the second cushion.

12. A wheelchair as recited in claim 1, wherein the second cushion comprises memory foam or quilting batting.

13. A wheelchair as recited in claim 1, wherein at least one of the first and second cushions comprises a removable cover.

14. A wheelchair as recited in claim 1, wherein:
the frame includes a first rail having a first wheel coupled thereto and a second rail having a second wheel coupled thereto, the rails being connected by a crossbar; and
the crossbar includes a bracket coupled thereto, bracket being connected to the a first end of the collection container to fix the collection container relative to the frame.

15. A wheelchair as recited in claim 14, wherein:
a first post extends perpendicularly from the first rail and a second post extends perpendicularly from the second rail; and
a stabilization member extends between the posts, the stabilization member comprising a hook that engages a flange at a second end of the collection container to stabilize the collection container.

16. A wheelchair as recited in claim 1, wherein:
the frame includes a first side comprising a first small wheel and a first large wheel and a second side comprising a second small wheel and a second large wheel; and
each of the wheels includes a covering configured to conceal the collection container from view.

17. A wheelchair as recited in claim 1, wherein:
the frame includes a first rail having a first wheel coupled thereto and a second rail having a second wheel coupled thereto, the rails being connected by a crossbar;
the frame includes third and fourth rails that are positioned between the first and second rails, the cushions being positioned between the rails;
a protection flap extends perpendicularly from the third rail so as to conceal the collection container from view.

18. A method of assembling a wheelchair, comprising:
providing the wheelchair recited in claim 1;
positioning a first cushion on a seat of the wheelchair such that the first aperture is aligned with a throughhole extending through the seat;
positioning the receiving member in the first aperture such that a bottom surface of a flange of the receiving member engages an upper surface of the first cushion and the second end of the receiving member extends through the throughhole;
positioning the second cushion relative to the first cushion such that a bottom surface of the second cushion engages a top surface of the first cushion and a top surface of the flange;
engaging the drainage member with the receiving member such that the passageway is in communication with the channel; and
positioning the collection container relative to the drainage member such that the passageway is in communication with a cavity defined by an inner surface of the collection container.

19. A wheelchair kit, comprising:
a wheelchair frame; and
a wheelchair seat configured to be attached to the frame, the seat comprising:
at least one first cushion comprising an inner surface defining a first aperture,
at least one second cushion comprising an inner surface defining a second aperture,
at least one receiving member configured to be positioned between the cushions and comprising an inner surface defining a channel having a first opening at a first end of the receiving member and a second opening at a second end of the receiving member,
at least one drainage member configured to be coupled to the second end of the receiving member and comprising an inner surface defining a passageway that is in communication with each of the apertures and the channel, the passageway comprising a third opening at a first end of the drainage member and a fourth opening at a second end of the drainage member, and
at least one collection container configured to be positioned adjacent the second end of the drainage member.

20. A wheelchair, comprising:
a wheelchair frame; and
a wheelchair seat attached to the frame, the seat comprising:
a first cushion comprising an inner surface defining a first aperture, the first cushion comprising memory foam or quilting batting,
a second cushion comprising an inner surface defining a second aperture, the first cushion having a density that is greater than that of the second cushion,
a receiving member positioned between the cushions and comprising an inner surface defining a channel having a first opening at a first end of the receiving member and a second opening at a second end of the receiving member, wherein the first opening has a maximum diameter that is greater than that of the second opening, the channel being tapered between the first and second ends,
a drainage member defining a funnel comprising a flexible material, the drainage member being coupled to the second end of the receiving member and comprising an inner surface defining a passageway that is in communication with each of the apertures and the channel, the passageway comprising a third opening at a first end of the drainage member and a fourth opening at a second end of the drainage member, and
a collection container positioned adjacent the second end of the drainage member,
wherein the receiving member comprises a body that includes the channel and a flange extending outwardly from an upper surface of the body such that a bottom surface of the flange engages a top surface of the first cushion and a top surface of the flange engages a bottom surface of the second cushion to fix the receiving member relative to the cushions, and
wherein the receiving member extends along a longitudinal axis between the first and second ends thereof, the channel having a first portion adjacent the first opening that extends transverse to the longitudinal axis and a second portion adjacent the second opening that extends parallel to the longitudinal axis, the second portion extending at an angle of about 60 degrees relative to the longitudinal axis.
